(19) United States
(12) Patent Application Publication
(10) Pub. No.: US 2018/0072210 A1
(43) Pub. Date: Mar. 15, 2018

(54) CUP HOLDER INSERT

(71) Applicant: FORD GLOBAL TECHNOLOGIES, LLC, Dearborn, MI (US)

(72) Inventors: David R. Huelke, Milan, MI (US); Adrienne Huelke, Ypsilanti, MI (US); Eric Axel Smitterberg, Berkley, MI (US)

(21) Appl. No.: 15/264,662

(22) Filed: Sep. 14, 2016

(51) Int. Cl. B60N 3/10; B60R 11/02; H02J 7/14; H02J 7/00

(52) U.S. Cl. CPC B60N 3/108; B60N 3/103; B60R 11/0241; B60R 2011/0007; H02J 7/14; H02J 7/0052; B60R 11/0252

(57) ABSTRACT

A cup holder insert for a vehicle includes a support receiver dimensioned for holding the cup holder insert in a vehicle cup holder receive, at least one secondary receiver carried by the support receiver, and at least one retaining receiver including a retainer. The retainer may include a biasing member configured to urge the retainer into retaining contact with an item held in the one retaining receiver. The at least one retaining receiver further includes a retaining receiver electrical contact disposed to place an electronic device held by the retainer in electrical communication with another device.

### TECHNICAL FIELD

This disclosure relates generally to vehicle cup holders. More particularly, the disclosure relates to a cup holder insert for expanding capacity and capabilities of a vehicle's existing cup holders.

### BACKGROUND

Cup holders are a great convenience to motor vehicle users, providing a receiver for containers such as cups, glasses, etc. whereby the user need not continually hold the container in her hand to avoid spillage during motor vehicle operation. However, packaging space for conveniences such as cup holders in a modern motor vehicle can be limited. Thus, due to packaging constraints, manufacturers may be required to include fewer such conveniences than is desired by the consumer.

Moreover, for convenience users often stow items other than beverage containers in the cup holder receivers. For example, users may wish to set electronic devices such as smartphones, cell phones, small tablets, etc. in a cup holder for easy access. Conventional cup holders do not include suitable snug holders for such electronic devices, raising issues of safety and potential damage to items held loosely in a receiver not dimensioned for that item. In turn, stowing such alternative items in a cup holder receiver further reduces the availability of the vehicle cup holders to in fact hold cups and other beverage receptacles.

To solve this and other problems, the present disclosure relates to a cup holder adapter for installation in a vehicle cup holder. The cup holder insert expands the available receivers available for holding beverage containers and other items, and further includes additional features to improve user convenience.

### SUMMARY

In accordance with the purposes and benefits described herein, in one aspect a cup holder insert for a vehicle is provided, comprising a support receiver dimensioned for holding the cup holder insert in a vehicle cup holder receiver and at least one secondary receiver carried by the support receiver. The cup holder insert further comprises at least one retaining receiver including a retainer. In embodiments, the retainer includes a biasing member configured for urging the retainer into retaining contact with an item held in the one retaining receiver.

The at least one retaining receiver further comprises a retaining receiver electrical contact disposed to place an electronic device held by the retainer in electrical communication with another device. The another device may be a power source for charging the electronic device. In embodiments, the power supply may be a vehicle power supply or a battery held in the support receiver.

The another device may be a vehicle entertainment system. In embodiments, the support receiver further comprises one or more support receiver electrical contacts for placing the retaining receiver electrical contact in electrical communication with the vehicle entertainment system and/or the vehicle power supply.

In another aspect, an accessory system for a vehicle is described, comprising at least one vehicle-mounted cup holder comprising at least one cup holder electrical contact in electrical communication with a vehicle power source and/or a vehicle entertainment system and a cup holder insert as described above.

In the following description, there are shown and described embodiments of the disclosed cup holder insert. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed cup holder insert, and together with the description serve to explain certain principles thereof. In the drawing:

FIG. 1 depicts an embodiment of a cup holder insert for a vehicle console according to the present disclosure; and

FIG. 2 depicts an alternative embodiment of a cup holder insert for a vehicle console according to the present disclosure.

Reference will now be made in detail to embodiments of the disclosed cup holder insert, examples of which are illustrated in the accompanying drawing figures.

### DETAILED DESCRIPTION

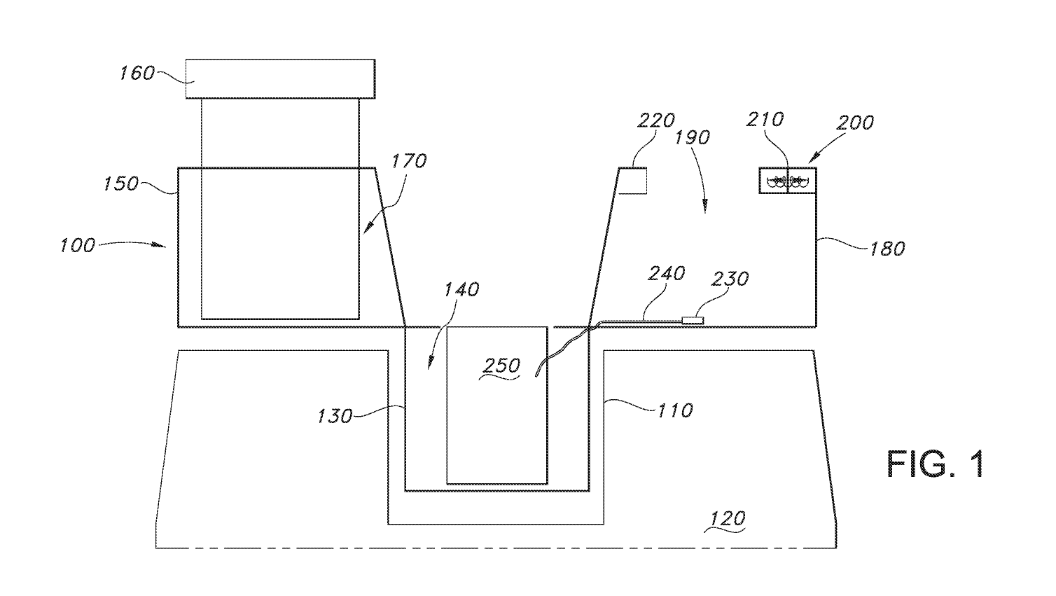

With reference to FIG. 1 there is shown a cup holder insert 100 for use in expanding the capacity/capabilities of a vehicle cup holder 110, such as a cup holder disposed in a vehicle console 120. However, it will be appreciated that the described cup holder insert 100 is readily adaptable to any vehicle cup holder structure, and so the disclosures herein relating to vehicle console-mounted cup holders 110 should not be taken as limiting.

The cup holder insert 100 includes a support receiver 130 dimensioned and configured to hold the cup holder insert in the cup holder 100. The support receiver 130 may be configured to define any suitable exterior cross-section, i.e. cylindrical, rectangular, square, etc., according to the interior dimensions/configuration of the vehicle cup holder 110 and any holding devices such as flexible pads, biasing mechanical fingers, etc. which may be provided to create a snug fit for items placed within the vehicle cup holder. As will be described, the support receiver defines an interior holder 140 which may receive and hold items such as beverage containers as well as other items described below.

The support receiver 130 carries a number of supplemental receivers. In particular, the support receiver 130 carries at least one secondary receiver 150 dimensioned and configured to hold an item such as a beverage cup 160 or other items. The at least one secondary receiver 150 may define an interior holder 170 having any suitable interior cross-section, i.e. cylindrical, rectangular, square, etc., according to the exterior dimensions/configuration of items anticipated to be carried in the secondary receiver.

The support receiver 130 also carries at least one retaining receiver 180, which is likewise dimensioned and configured to define an interior receiver 190 to hold an item such as a beverage cup or other items. The retaining receiver 180 defines an interior holder 190 having any desired interior cross-section, i.e. cylindrical, rectangular, square, etc.

The retaining receiver 180 is further provided with a retainer 200 for holding an item in place. Use of any suitable retainer 200 is contemplated, for example retainers providing an interference or friction fit for items placed in the interior holder 190, or others. In the depicted embodiment, the retainer 200 comprises a biasing member 210 urging a portion of the retainer into contact with items held in the interior holder 190, such as for example a spring-loaded slide retainer. The retaining receiver 180 may further be provided with a stop 220 disposed opposite to the retainer 200, to provide a surface against which the retainer urges an item held in the retaining receiver.

The retaining receiver 180 further includes an electrical contact 230 in electrical contact with a power supply which will be further described below. As will be appreciated, by the electrical contact 230 an electronic device such as a cell phone, smart phone, small tablet, etc. may be connected to a power supply and/or to an information source such as a network. Any suitable electrical contact 230 for providing this function is contemplated, including without intending any limitation suitably configured ports for receiving correspondingly configured charging plugs, USB ports, wireless charging stations, and others.

The electrical contact 230 is in electrical communication with at least a power supply by way of a wire or cable 240. In the embodiment of FIG. 1, this may be a dedicated battery 250 held in the support receiver 130. As will be appreciated, the battery 250 could be held loosely in the interior holder 140, but more conveniently will be held in a battery case (not shown for convenience) held in, on, or under the interior holder 140 to maximize the available space for holding other items. Use of any suitable battery technology having sufficient power to charge/re-charge an electronic device is contemplated, including replaceable batteries, rechargeable batteries, etc.

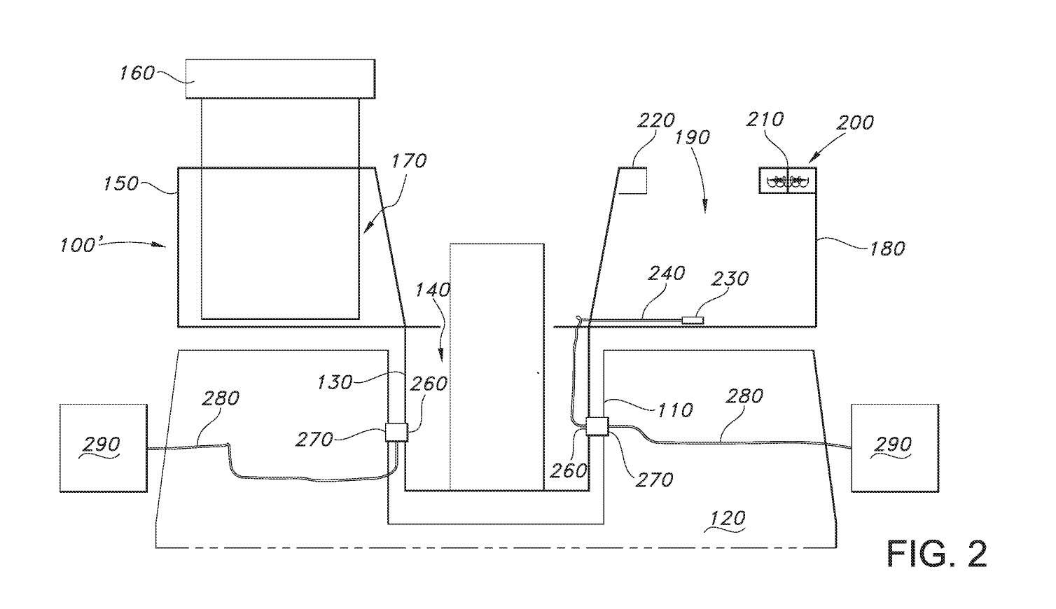

In an alternative embodiment depicted in FIG. 2, a cup holder insert 100′ is provided configured substantially as described above. In this alternative embodiment, the electrical contact 230 is in electrical communication with at least one support receiver 130-mounted electrical contact 260 by way of the wire or cable 240. The at least one electrical contact 260 is disposed to, when the cup holder insert 100′ is properly placed within the console cup holder 110, come into mating contact with cooperating cup holder 110 electrical contacts 270. By this mating contact, the electrical contact 230 is placed in electrical communication by way of a wire or cable 280 with a power supply and/or a vehicle entertainment system depicted generally as reference numeral 290. As will be appreciated, the power supply may be a vehicle-associated power supply such as the vehicle battery or a separate battery (not shown in this view).

In turn, the technology (cables, etc.) for connecting an electronic device such as a smartphone or tablet computing device to a network via devices such as a vehicle entertainment system is well known to the skilled artisan, and does not require extensive discussion herein. However, as will be appreciated, by such a connection the electronic device may be enabled to access various functionalities associated with a modern vehicle entertainment network, for example a wi-fi connection, GPS functions, etc. Likewise, by such a connection the vehicle entertainment system may be able to access certain electronic device functionalities, for example to access electronic device GPS functions, to use the electronic device as a wi-fi “hotspot,” to access and play or display information stored on the electronic device such as music, audio books, and other functions. As non-limiting examples, MP1 and/or USB plugs may be provided connected to wiring arranged on a self-winding roll to allow connection to a vehicle entertainment center as needed.

Obvious modifications and variations are possible in light of the above teachings. For example, multiple support receiver electrical contacts 270 are depicted, but in an alternative embodiment a single electrical contact 270 could be provided having common or separate wiring/cabling for placing an electronic device into electrical communication with both a vehicle power supply and a vehicle entertainment system. Likewise, the depicted embodiments of the cup holder insert 100 show a single secondary receiver 150 and a single retaining receiver 180, but additional secondary receivers 150 and retaining receivers 180 carried by the support receiver 110 are of course possible and contemplated. The depicted embodiments show cup holder inserts 100, 100′ configured for use in a vehicle center console 120, but alternative configurations are contemplated for use in a vehicle door, dash panel, etc. All such modifications and variations are within the scope of the appended claims when interpreted in accordance with the breadth to which they are fairly, legally and equitably entitled.

What is claimed:

1. A cup holder insert for a vehicle, comprising:
a support receiver dimensioned for holding the cup holder insert in a vehicle cup holder receiver; and
at least one secondary receiver carried by the support receiver; and
at least one retaining receiver including a retainer.

2. The cup holder insert of claim 1, including a biasing member configured for urging the retainer into retaining contact with an item held in the one retaining receiver.

3. The cup holder insert of claim 1, wherein the at least one retaining receiver further comprises a retaining receiver electrical contact disposed to place an electronic device held by the retainer in electrical communication with another device.

4. The cup holder insert of claim 3, wherein the another device is a power source for charging the electronic device.

5. The cup holder insert of claim 4, wherein the power source is a vehicle power supply.

6. The cup holder insert of claim 4, wherein the power source is a battery held in the support receiver.

7. The cup holder insert of claim 5, wherein the support receiver further comprises one or more support receiver electrical contacts for placing the retaining receiver electrical contact in electrical communication with a vehicle entertainment system and/or the vehicle power supply.

8. A cup holder insert for a vehicle, comprising:
a support receiver dimensioned for holding the cup holder insert in a vehicle cup holder receiver; and
at least one retaining receiver including a retainer and a retaining receiver electrical contact for placing an electronic device held by the retainer in electrical communication with another device.

9. The cup holder insert of claim 8, further including at least one secondary receiver carried by the support receiver.

10. The cup holder insert of claim 8, including a biasing member configured for urging the retainer into retaining contact with an item held in the at least one retaining receiver.

11. The cup holder insert of claim 8, wherein the another device is a power source for charging the electronic device.

12. The cup holder insert of claim 11, wherein the power source is a vehicle power supply.

13. The cup holder insert of claim 11, wherein the power source is a battery held in the support receiver.

14. The cup holder insert of claim 12, wherein the support receiver further comprises one or more support receiver electrical contacts for placing the retaining receiver electrical contact in electrical communication with a vehicle entertainment system and/or the vehicle power supply.

15. An accessory system for a vehicle, comprising:
at least one vehicle-mounted cup holder comprising at least one cup holder electrical contact in electrical communication with a vehicle power source and/or a vehicle entertainment system; and
a cup holder insert, comprising:
a support receiver dimensioned for holding the cup holder insert in the vehicle-mounted cup holder; and
at least one retaining receiver including a retainer.

16. The accessory system of claim 14, including a biasing member configured for urging the retainer into retaining contact with an item held in the at least one retaining receiver.

17. The accessory system of claim 14, wherein the at least one retaining receiver further comprises a retaining receiver electrical contact disposed to place an electronic device held by the retainer in electrical communication with another device.

18. The accessory system of claim 16, wherein the another device is a power source for charging the electronic device.

19. The accessory system of claim 17, wherein the power source is a battery held in the support receiver.

20. A vehicle including the accessory system of claim 14.
